(19) United States
(12) Patent Application Publication
(10) Pub. No.: US 2018/0174127 A1
(43) Pub. Date: Jun. 21, 2018

(54) SETTLEMENT PROCESSING DEVICE AND METHOD, AND COMPUTER PROGRAM

(71) Applicant: Masahiro TAKASAKI, Tokyo (JP)

(72) Inventor: Yoshikazu TAKASAKI, Tokyo (JP)

(21) Appl. No.: 15/707,332

(22) PCT Filed: Mar. 18, 2016
(86) PCT No.: PCT/JP2016/058814

§ 371 Date: Sep. 18, 2017

(30) Foreign Application Priority Data
Mar. 19, 2015 (JP) 2015-056663
Mar. 18, 2016 (JP) 2016-055421

(51) Int. Cl. G06Q 20/24; G06Q 40/02

(52) U.S. Cl. CPC G06Q 20/24; G06Q 40/025

(57) ABSTRACT

A settlement processing apparatus can communicate with a store terminal through a network and includes a salary information DB storing salary information Including an expected salary of a worker, a settlement information DB storing settlement information including a settlement amount for merchandise purchased by the worker, and a credit authorization processing unit that receives a credit authorization along with information on a requested amount for settlement required to purchase the merchandise from the store terminal. The credit authorization processing unit executes credit authorization processing with a credit line set to the expected salary of the worker by referring to the salary information DB, and transmits a result of the credit authorization processing to the store terminal. A settlement processing unit registers the settlement information in the settlement information DB after receiving a settlement request from the store terminal.

### TECHNICAL FIELD

The present invention relates to a technology which performs a credit transaction with a credit line set to a salary scheduled to be paid to a worker.

### RELATED ART

In general, a salary of a blue-collar worker is summed up by a week, half a month or a month on a predetermined date such as the end of the month or week, and paid to the worker at a later date in many cases. In such case, a low-income worker in particular sometimes cannot wait till a payday for the salary to be paid and wishes to appropriate the salary that is already confirmed or is scheduled to be paid for merchandise purchase or payment, but an advance loan or payment is not granted in many cases as it is troublesome for an employer.

When the worker does not have cash in hand, on the other hand, he can possibly choose a credit transaction by using a credit card or the like, which cannot be issued unless he passes a credit check. A deposit-type credit card and electronic money in which money is deposited in advance are also becoming popular but require an advance deposit so that one who does not have cash in hand cannot use those for the merchandise purchase or payment.

Moreover, the worker having no cash but wishing to make merchandise purchase or payment has no choice but to borrow from a loan company or consumer finance while unable to use labor credits or money lent to a company he actually works for. Especially, a worker in a developing country does not even have a bank account in many cases and can barely use credit card settlement or the like in reality.

In this respect, JP 2009-075925 A proposes a payroll management server including: a worker information database which is connected to a cash dispenser through a communication unit and manages information on a worker; a company information database which manages information on a company in which the worker takes part; a cash dispenser input information reception unit which receives worker information to identify the worker as well as a requested withdrawal amount input through the cash dispenser; a withdrawal amount information transmission unit which transmits, to the cash dispenser, a piece of withdrawal amount information used to withdraw a predetermined amount of money; an amount comparison unit which reads remaining salary information on the salary not yet withdrawn from the worker information, database by using the worker information received from the cash dispenser input information reception unit and compares the remaining salary and the requested withdrawal amount; and a withdrawal amount determination unit which determines the request withdrawal amount as the withdrawal amount information when the amount comparison unit determines that the requested withdrawal amount equals the remaining salary or lower and then transfers the information to the withdrawal amount information transmission unit, where the payroll management server further includes a credit determination unit which determines credit of the worker so that, when the amount comparison unit determines that the requested withdrawal amount is higher than the remaining salary, the credit determination unit determines the credit of the worker, and the withdrawal amount determination unit adds a difference between the requested withdrawal amount and the remaining salary to the remaining salary within the range of an available credit set by the credit determination unit, determines the amount as the withdrawal amount information, and transfers the information to the withdrawal amount information transmission unit.

### SUMMARY

According to JP 2009-075925 A, cash is lent to a worker on the basis of a salary, but the worker cannot use a cash dispenser when he does not have an account into which the salary is paid, as described above. Moreover, it is fine as far as the worker can purchase merchandise not necessarily by borrowing cash but by using a credit card, in which case the worker has a low risk of carrying cash.

Accordingly, an object of the present invention is to allow for a credit transaction that pays for a worker when he purchases merchandise on the basis of an expected salary that is scheduled to be paid to the worker.

In order to achieve the aforementioned object, according to an aspect of the present invention, there is provided a settlement processing apparatus which is configured to be able to communicate with a store terminal selling merchandise to a worker through a network and performs a credit transaction that pays for the worker when he purchases merchandise on the basis of an expected salary scheduled to be paid to the worker, the apparatus including: a salary information storage unit that stores salary information including the expected salary of the worker; a settlement information storage unit that stores settlement information including a settlement amount for the merchandise purchased by the worker; a credit authorization reception unit that receives credit authorization along with information on a requested amount for settlement from the store terminal, the amount being required in the merchandise purchase; a credit authorization processing unit that executes credit authorization processing with a credit line set to the expected salary of the worker while referring to the salary information storage unit; a result transmission unit that transmits a result of the credit authorization processing to the store terminal; a settlement request reception unit that receives a settlement request from the store terminal; a settlement processing unit that registers settlement information in the settlement information storage unit on the basis of the settlement request; and a payment calculation unit that calculates a salary payment by referring to the salary information storage unit and the settlement information storage unit and deducting the settlement amount from the expected salary.

The settlement processing apparatus may be adapted to further include a salary payment processing unit that executes salary payment processing of paying the calculated salary payment to the worker.

The settlement processing apparatus may be adapted to further include a first credit line calculation unit that calculates, as the credit line, a first settleable amount by referring to the salary information storage unit and the settlement information storage unit and deducting the settlement amount from the expected salary, where the credit authorization processing unit executes credit authorization processing with the credit line set to the first settleable amount.

The settlement processing apparatus may be adapted to further include a second credit line calculation unit that calculates, as the credit line, a second settleable amount by referring to the salary information storage unit and multiplying the expected salary of the worker by a predetermined rate, where the credit authorization processing unit executes credit authorization processing with the credit line set to the second settleable amount.

The settlement processing apparatus may be adapted such that the second credit line calculation unit calculates, as the credit line, a third settleable amount by referring to the salary information storage unit and the settlement information storage unit, and multiplying the expected salary of the worker by a predetermined rate as well as subtracting the settlement amount from a product.

The settlement processing apparatus may be adapted to further include: a point calculation unit that calculates a predetermined number of points by referring to the settlement information storage unit and multiplying the settlement amount by a predetermined rate; and a point giving unit that associates the calculated number of points with the worker by referring to the settlement information storage unit and gives the points to the worker.

Moreover, according to another aspect of the present invention, there is provided a settlement processing method employed to perform a credit transaction that pays for a worker when he purchases merchandise on the basis of an expected salary scheduled to be paid to the worker, where a computer configured to be able to communicate with a store terminal selling merchandise to the worker through a network includes: a salary information storage unit that stores salary information including the expected salary of the worker; and a settlement information storage unit that stores settlement information including a settlement amount for the merchandise purchased by the worker, and the method causes the computer to execute: processing that receives credit authorization along with information on a requested amount for settlement from the score terminal, the amount being required in the merchandise purchase; processing that executes credit authorization processing with a credit line set to the expected salary of the worker while referring to the salary information storage unit; processing that transmits a result of the credit authorization processing to the store terminal; processing that receives a settlement request from the store terminal; processing that registers settlement information in the settlement information storage unit on the basis of the settlement request; and processing that calculates a salary payment by referring to the salary information storage unit and the settlement information storage unit and deducting the settlement amount from the expected salary.

Furthermore, according to yet another aspect of the present invention, there is provided a computer program employed to perform a credit transaction that pays for a worker when ha purchases merchandise on the basis of an expected salary scheduled to be paid to the worker, where a computer configured to be able to communicate with a store terminal selling merchandise to the worker through a network includes: a salary information storage unit that stores salary information including the expected salary of the worker; and a settlement information storage unit that stores settlement information including a settlement amount for the merchandise purchased by the worker, and the computer program causes the computer to execute: processing that receives credit authorization along with information on a requested amount for settlement from the store terminal, the amount being required in the merchandise purchase; processing that executes credit authorization processing with a credit line set to the expected salary of the worker while referring to the salary information storage unit; processing that transmits a result of the credit authorization processing to the store terminal; processing that receives a settlement request from the store terminal; processing that registers settlement information in the settlement information storage unit on the basis of the settlement request; and processing that calculates a salary payment by referring to the salary information storage unit and the settlement information storage unit and deducting the settlement amount from the expected salary.

There is allowed the credit transaction that pays for the worker when he purchases merchandise on the basis of the expected salary that is scheduled to be paid to the worker. As a result, the worker can purchase merchandise as needed without waiting till a payday or the need to have an account in a bank or the like.

### BRIEF DESCRIPTION OF DRAWINGS

FIG. 1 is a functional block diagram illustrating a function included in a settlement processing apparatus according to a first embodiment of the present invention;

FIG. 2 is a table illustrating an example of data stored in a worker information DB in the settlement processing apparatus of the present embodiment;

FIG. 3 is a table illustrating an example of data stored In a salary information DB in the settlement processing apparatus of the present embodiment;

FIG. 4 is a table illustrating an example of data stored in a settlement information DB in this settlement processing apparatus of the present embodiment;

FIG. 5 is a sequence diagram illustrating the flow of processing performed by the settlement processing apparatus of the present embodiment;

FIG. 6 is a sequence diagram illustrating the flow of processing performed by the settlement processing apparatus of the present embodiment;

FIG. 7 is a processing flow diagram illustrating the flow of processing performed by the settlement processing apparatus of the present embodiment;

FIG. 8 is a functional block diagram illustrating a function included in a settlement processing apparatus according to a second embodiment of the present invention; and

FIG. 9 is a sequence diagram illustrating the flow of processing performed by the settlement processing apparatus of the present embodiment.

### DETAILED DESCRIPTION

A settlement processing apparatus according to an embodiment of the present invention will now be described with reference to the drawings.

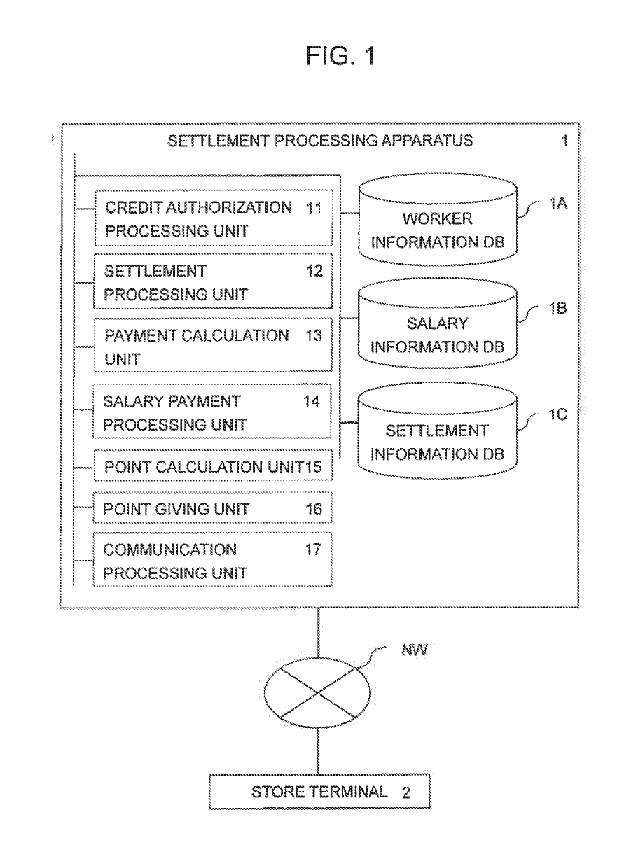

FIG. 1 illustrates a configuration of a settlement processing apparatus 1 according to a first embodiment.

The settlement processing apparatus 1 is a device which manages a salary of a worker working for a company and performs a credit transaction that pays for the worker when he purchases merchandise on the basis of the salary, and is configured to be able to communicate with a store terminal 2 through a network NW such as the Internet, the store terminal being used by a store at which the worker purchases merchandise.

Note that merchandise in the merchandise purchase according to the present example is not limited to tangible or intangible goods and movables or immovables, but also includes a transaction in general that at least has a price such as an intangible service.

The settlement processing apparatus 1 is realized by a so-called server computer or the like and uses hardware resources including a Central Processing Unit (CPU), a Random Access Memory (RAM), a Read Only Memory (ROM) and a hard disk drive as well as a software resource including a computer program run by the CPU to configure a functional block including a credit authorization processing unit 11, a settlement processing unit 12, a payment calculation unit 13, a salary payment processing unit 14, a point calculation unit 15, a point giving unit 16, a communication processing unit 17, a worker information DB 1A, a salary information DB 1B, and a settlement information DB 1C.

The worker information DB 1A is a storage storing information on a worker.

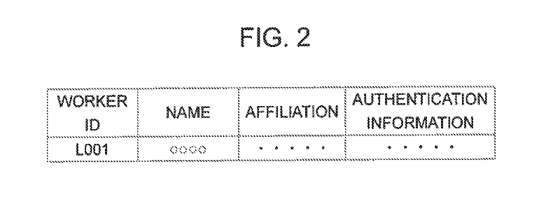

For each worker ID identifying a worker, as illustrated in FIG. 2, the worker information DB 1A for example stores worker's name, affiliation, and authentication information used to authenticate the worker in a settlement performed by the settlement processing apparatus 1 of the present embodiment.

The salary information DB 1B is a storage storing salary information of each worker.

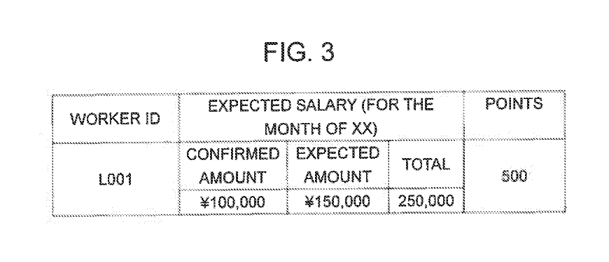

As illustrated in FIG. 3, for example, the salary information DB 1B stores an expected salary as the salary information in association with each worker ID identifying a worker. The expected salary is an amount of salary that is scheduled to be paid to a worker each month, for example. In the present example, the expected salary is a total of a confirmed amount based on a work record up to that point and an expected amount based on a future work schedule.

The salary information DB 1B also stores the number of points given to the worker at a predetermined rate when a credit transaction is performed by the settlement processing apparatus 1 according to the present embodiment.

Note that the salary information stored in the salary information DB 1B may also include information such as an account to which the salary is paid according to circumstances of the worker.

The settlement information DB 1C is a storage storing settlement information of a credit transaction when the transaction is performed by a worker with use of the settlement processing apparatus 1 of the present embodiment.

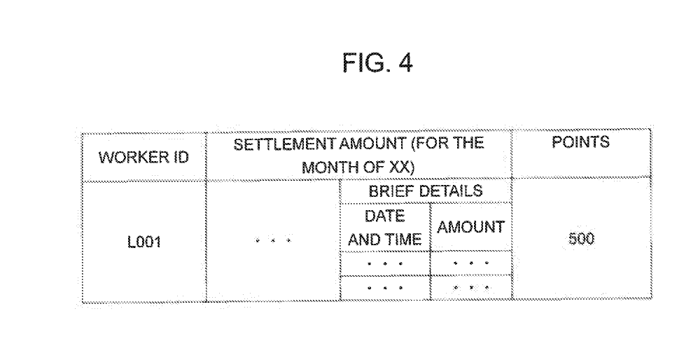

For each worker ID identifying a worker, as illustrated in FIG. 4, the settlement information DB 1C for example stores a settlement amount in every settlement period corresponding to the unit of a week, half a month, or a month (FIG. 4 illustrates an example of the monthly settlement period) as well as information such as brief details of the settlement amount including date and time and an amount of the settlement.

The credit authorization processing unit 11 executes credit authorization processing with a credit line set to the expected salary of the worker by referring to a salary information storage unit on the basis of a credit authorization received from the store terminal 2.

Specifically, in the credit authorization processing, the expected salary of the worker is identified by referring to the salary information DB 1B when the credit authorization is received from the store terminal 2 along with information such as a predetermined ID identifying the worker and a requested amount for settlement that is required to purchase merchandise. Then, with the credit line set to the expected salary, it is determined whether or not the requested amount for settlement required to purchase the merchandise falls within the credit line. The processing proceeds to settlement processing when the requested amount is determined to fall within the credit line and, when determined to not fall within the credit line, error processing is executed to notify the store terminal 2 of such determination, and the processing is completed.

The settlement processing unit 12 executes the settlement processing when it is determined as a result of the credit authorization that a settlement can be performed. Specifically, the settlement processing unit first receives from the store terminal 2 a settlement request according to the details of the credit authorization along with authentication information of the worker required in the settlement, and executes authentication processing based on whether the authentication information matches or does not match information in the worker information DB 1A while referring thereto. When the authentication succeeds, settlement information including the requested amount for settlement as the settlement amount is registered into the settlement information DB 1C. Moreover, the communication processing unit 17 transmits a notification to the effect that the settlement processing is completed to the store terminal 2.

The payment calculation unit 13 calculates the salary payment by referring to the salary information DB 1B and the settlement information DB 1C and deducting the settlement amount from the expected salary to be paid to the worker. That is, a part of the salary is appropriated to the settlement amount by deducting the settlement amount used in the credit transaction by the settlement processing apparatus 1 of the present embodiment from the salary.

The salary payment processing unit 14 executes processing of paying the worker the salary payment calculated by the payment calculation unit 13. When the worker has an account such as a bank account to which the salary is deposited, for example, this processing is executed by transmitting a request to deposit the payment to a terminal in a bank or the like managing the account to which the salary is deposited.

The point calculation unit 15 calculates a predetermined number of points by referring to the settlement information DB 1C and multiplying the settlement amount by a predetermined rate.

The point giving unit 16 stores the points calculated by the point calculation unit 15 in association with the worker while referring to the settlement information DB 1C, and gives the points to the worker. This processing is meant to give an incentive to the worker to perform the credit transaction by the settlement processing apparatus 1 of the present embodiment where, for example, 1% of the settlement amount is returned to the worker in the form of points. The points can be appropriated to the settlement amount at a predetermined rate from next time or exchanged with merchandise according to a predetermined agreement or the like.

The communication processing unit 17 is a functional unit that executes processing of transmitting/receiving various pieces of data to/from the store terminal 2 through the network NW.

The communication processing unit 17 allows the result of the credit authorization processing to be transmitted to the store terminal 2 as well as the credit authorization and settlement request to be received from the store terminal 2

The store terminal 2 is a terminal provided at a store at which the worker purchases merchandise and can also be a so-called personal computer or the like.

The store terminal 2 executes the processing of transmitting/receiving various pieces of data to/from the settlement processing apparatus 1 through the network NW and includes a unit that inputs/outputs data required to purchase merchandise. Such unit includes a card reader which acquires authentication information used to authenticate a worker in a settlement and an input button which accepts input of the authentication information from the worker, for example.

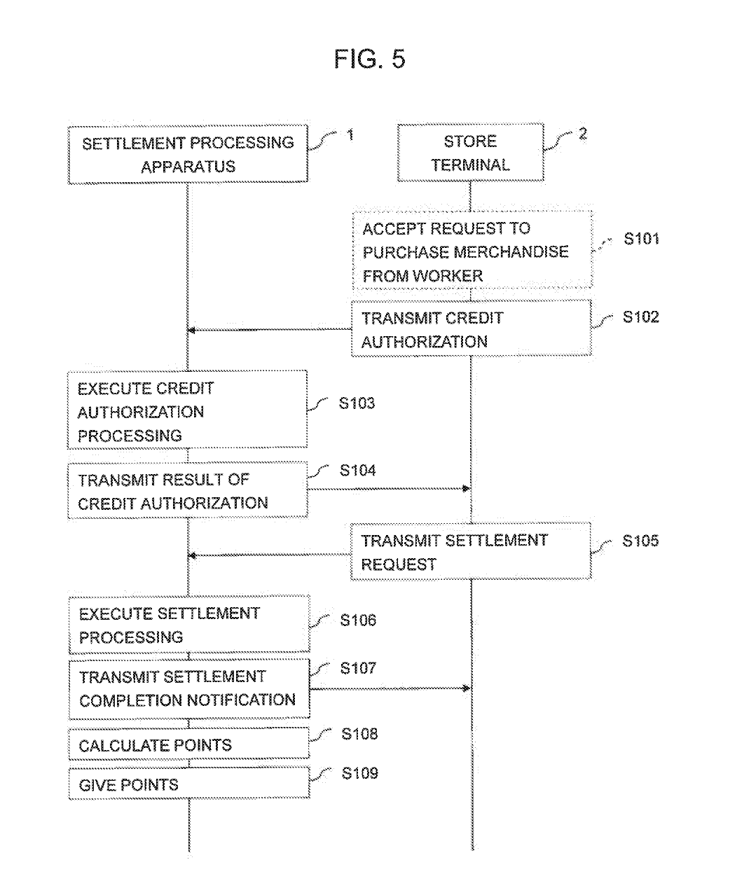

Next, the flow of processing performed by the settlement processing apparatus 1 according to the present embodiment will be described with reference to FIG. 5.

First, a worker requests a merchandise purchase at a predetermined store, which then accepts the request (S101). Concerning a settlement involved in the merchandise purchase, the worker requests the store to perform the settlement by using the settlement processing apparatus 1 and at the same time provides information identifying the worker and required in the settlement by the settlement processing apparatus 1 to the store.

Here, the information identifying the worker is a piece of information issued to the worker in advance in order to be used in the credit transaction based on the processing performed by the settlement processing apparatus 1, and can be formed of a character string being a combination of alphanumeric characters, where this information may also be stored in a readable medium such as an IC chip.

The store terminal 2 transmits to the settlement processing apparatus 1 a credit authorization along with the information identifying the worker and information on a requested amount for settlement required to purchase the merchandise (S102).

In response to the credit authorization transmitted, the credit authorization processing unit 11 of the settlement processing apparatus 1 executes credit authorization processing (S103). That is, the credit authorization processing unit 11 first refers to the salary information DB 1B and identifies an expected salary of the worker. Then, with the credit line sec to the expected salary, it is determined whether or not the requested amount for settlement required to purchase the merchandise falls within the credit line.

A result of the credit authorization is transmitted to the store terminal 2 (S104) and, when the worker is eligible for credit, a settlement request is transmitted from the store terminal 2 to the settlement processing apparatus 1 (S105).

The settlement request is transmitted along with predetermined authentication information the store terminal 2 acquires from the worker. The authentication information is preset by the worker and can be a personal identification number registered in the settlement processing apparatus 1 or electronic data of a signature acquired from the worker with use of a stylus pen or the like.

When the requested amount for settlement is determined to not fall within the credit line as a result of the credit authorization processing, error processing is executed to notify the store terminal 2 of such determination, and the processing is completed.

The settlement processing unit 12 executes settlement processing once the settlement processing apparatus 1 receives the settlement request from the store terminal 2 (S106). Specifically, the settlement processing unit executes authentication processing based on whether the authentication information matches or does not match information in the worker information DB 1A while referring thereto, on the basis of the authentication information of the worker received from the store terminal 2. When the authentication succeeds, the requested amount for settlement is determined as a settlement amount and settlement information including the settlement amount and settlement date and time is registered into the settlement information DB 1C. Note that when the authentication information is the electronic data of the signature of the worker and does not have data used to check whether the information matches or does not match in the authentication processing, it is considered that the authentication is successful or that necessary information is provided once the electronic data is acquired, whereby the electronic data is registered as a part of the settlement information into the settlement information DB 1C.

Upon completion of the settlement processing, the communication processing unit 17 transmits a notification to the effect that the settlement processing is completed to the store terminal 2 (S107).

When the settlement is completed, the point calculation unit 15 calculates a predetermined number of points by referring to the settlement information DB 1C and multiplying the settlement amount by a predetermined race (S108). The point giving unit 16 then refers to the settlement information DB 1C, stores the points calculated by the point calculation unit 15 in association with the worker, and gives the points to the worker (S109).

The settlement processing apparatus 1 according to the present embodiment as described above enables the credit transaction that pays for the worker when he purchases merchandise on the basis of the expected salary chat is scheduled to be paid to the worker. As a result, the worker can purchase merchandise as needed without waiting till a payday or the need to have an account in a bank or the like.

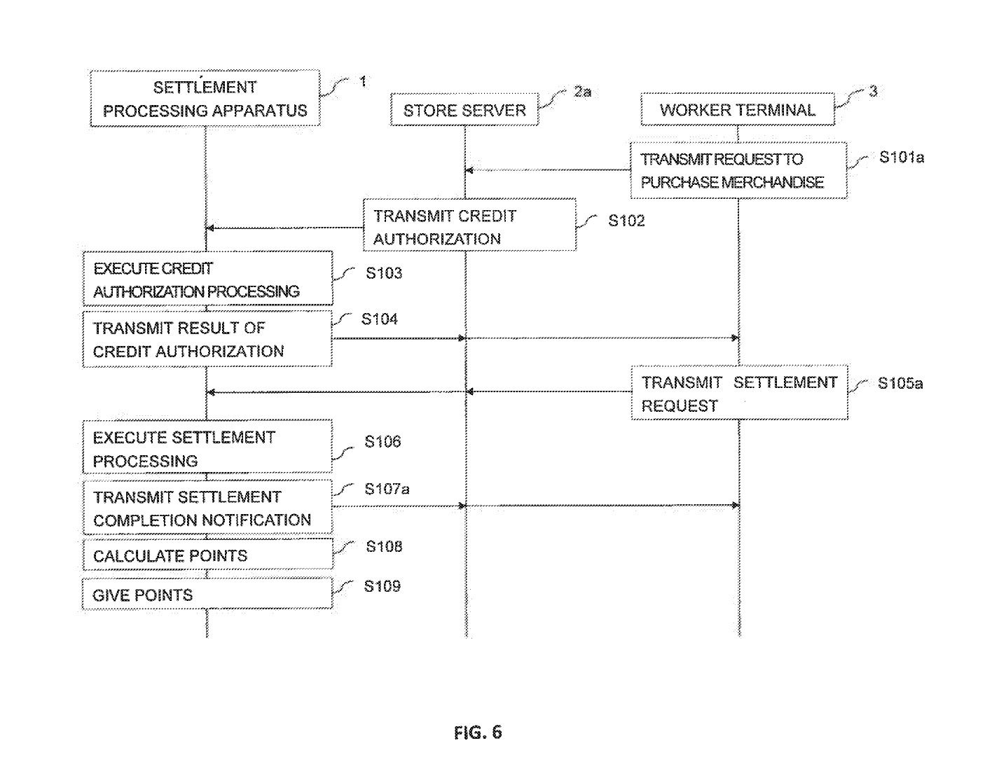

Note that in the present example, the worker purchases merchandise not only in a physical retail store but online such as on an e-commerce site, in which case processing is performed according to the flow illustrated in FIG. 6, for example.

In an online transaction such as on this e-commerce site as illustrated in the example in FIG. 6, a worker accesses an online store on the e-commerce site by using his own worker terminal 3 such as a personal computer or a tablet terminal or mobile phone capable of performing data communication, while the online store on the e-commerce site processes a transaction by a store server 2a. Note that for convenience of description, processing in FIG. 6 similar to the processing illustrated in FIG. 5 is assigned the same processing number as that assigned in FIG. 5.

First, the worker transmits a request to purchase merchandise on a predetermined e-commerce site to the online store, which receives the request on the store server 2a (S101a). Concerning a settlement involved in the merchandise purchase, the worker requests the store to perform the settlement by using the settlement processing apparatus 1 and at the same time provides information identifying the worker and required in the settlement by the settlement processing apparatus 1 to the store server 2a.

The store server 2a transmits to the settlement processing apparatus 1 a credit authorization along with the information identifying the worker and information on a requested amount for settlement required to purchase the merchandise (S102).

In response to the credit authorization transmitted, the credit authorization processing unit 11 of the settlement processing apparatus 1 executes credit authorization processing (S103).

A result of the credit authorization is transmitted to the store server 2a as well as the worker terminal 3 (S104).

When the credit authorization succeeds, the worker uses the worker terminal 3 and transmits a settlement request to the store server 2a, which then transmits the settlement request to the settlement processing apparatus 1 (S105a).

The settlement request is transmitted along with predetermined authentication information the store server 2a acquires from the worker. The authentication information is input from the worker terminal 3 by the worker and transmitted along with the settlement request to the store server 2a.

When the requested amount for settlement is determined to not fall within a credit line as a result of the credit authorization processing, error processing is executed to notify the worker terminal 3 of such determination through the store server 2a, and the processing is completed.

The settlement processing apparatus 1 receiving the settlement request from the store server 2a executes settlement processing by using the settlement processing unit 12 (S106) and, upon completion of the settlement processing, uses the communication processing unit 17 to transmit a notification to the effect that the settlement processing is completed to the store server 2a as well as the worker terminal 3 (S107a).

When the settlement is completed, the point calculation unit 15 calculates a predetermined number of points by referring to the settlement information DB 1C and multiplying a settlement amount by a predetermined rate (S108). The point giving unit 16 then refers to the settlement information DB 1C, stores the points calculated by the point calculation unit 15 in association with the worker, and gives the points to the worker (S109).

According to the aforementioned description, the settlement processing can be performed by the settlement processing apparatus 1 of the present embodiment on the e-commerce site similarly to the merchandise purchase made at a physical retail store.

Note that in the present embodiment described above, the points need not necessarily be calculated or added in every settlement, but may be calculated and added all at once at a timing when the price paid for the worker in the settlement is confirmed, in a case where the price is confirmed monthly and deducted from the salary of the worker.

Moreover, in the present embodiment described above, the salary is paid by a functional unit of each of the payment calculation unit 13 and the salary payment processing unit 14.

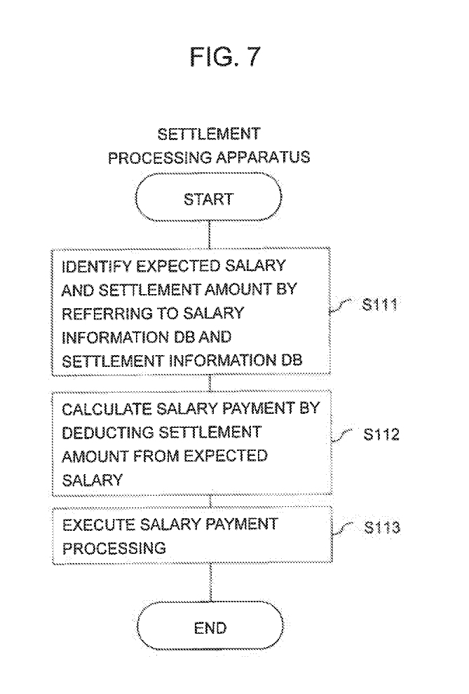

Specifically, as illustrated in FIG. 7, the payment calculation unit 13 first refers to the salary information DB 1B and the settlement information DB 1C and identifies the expected salary of the worker and the settlement amount (S111).

The salary payment is then calculated by deducting the settlement amount from the expected salary (S112). As a result, the settlement amount is deducted from the salary.

Moreover, the salary payment processing unit 14 executes processing of paying the worker the salary payment calculated by the payment calculation unit 13 (S113). When the worker has an account such as a bank account to which the salary is deposited, for example, this processing is executed by referring to the worker information DB 1A to identify the account to which the salary is deposited and then transmitting a request to deposit the payment to a terminal in a bank or the like managing the account to which the salary is deposited.

The payment is stored in the salary information DB 1B or the like and managed as worker information as appropriate.

Next, a settlement processing apparatus according to a second embodiment of the present invention will be described.

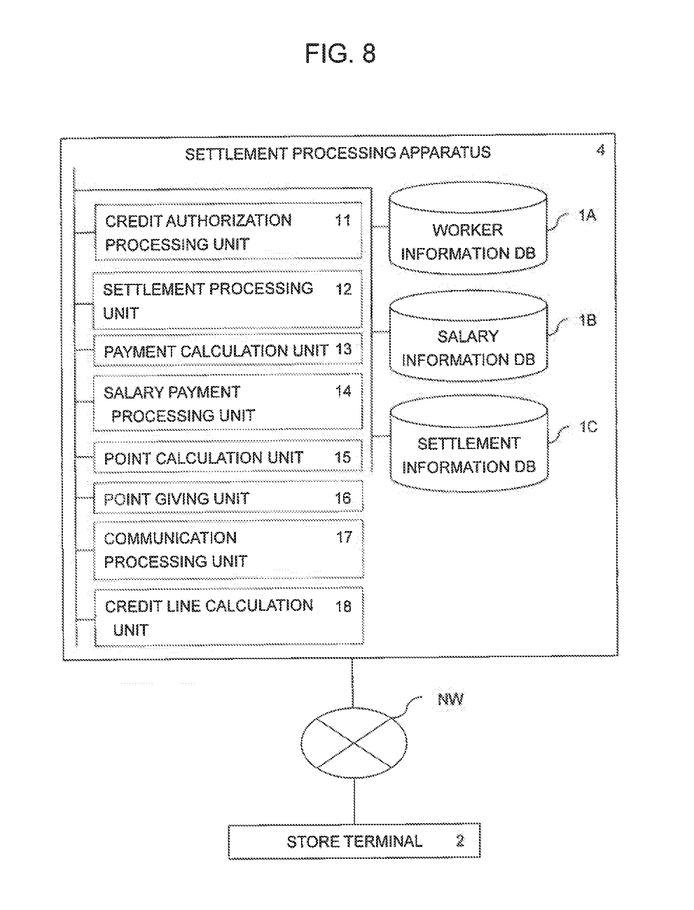

As illustrated in FIG. 8, a settlement processing apparatus 4 according to the second embodiment is realized by a so-called server computer or the like and uses hardware resources including a Central Processing Unit (CPU), a Random Access Memory (RAM), a Bead Only Memory (ROM) and a hard disk drive as well as a software resource including a computer program run by the CPU to configure a functional block including a credit authorization processing unit 11, a settlement processing unit 12, a payment calculation unit 13, a salary payment processing unit 14, a point calculation unit 15, a point giving unit 16, a communication processing unit 17, a worker information DB 1A, a salary information DB 1B, and a settlement information DB 1C that are similar to the ones provided in the first embodiment, and a credit line calculation unit 18.

The credit line calculation unit 18 executes processing of calculating a credit line within which a settlement can be performed when a worker purchases merchandise.

The credit line in the present example is an amount (hereinafter sometimes referred to as a “settleable amount”) obtained by deducting a settlement amount from an expected salary, and the credit line calculation unit 18 calculates the settleable amount as the credit line by referring to the salary information DB 1B and the settlement information DB 1C and deducting the settlement amount from the expected salary.

The credit authorization processing unit 11 then executes credit authorization processing with the credit line set to the settleable amount calculated by the credit line calculation unit 18.

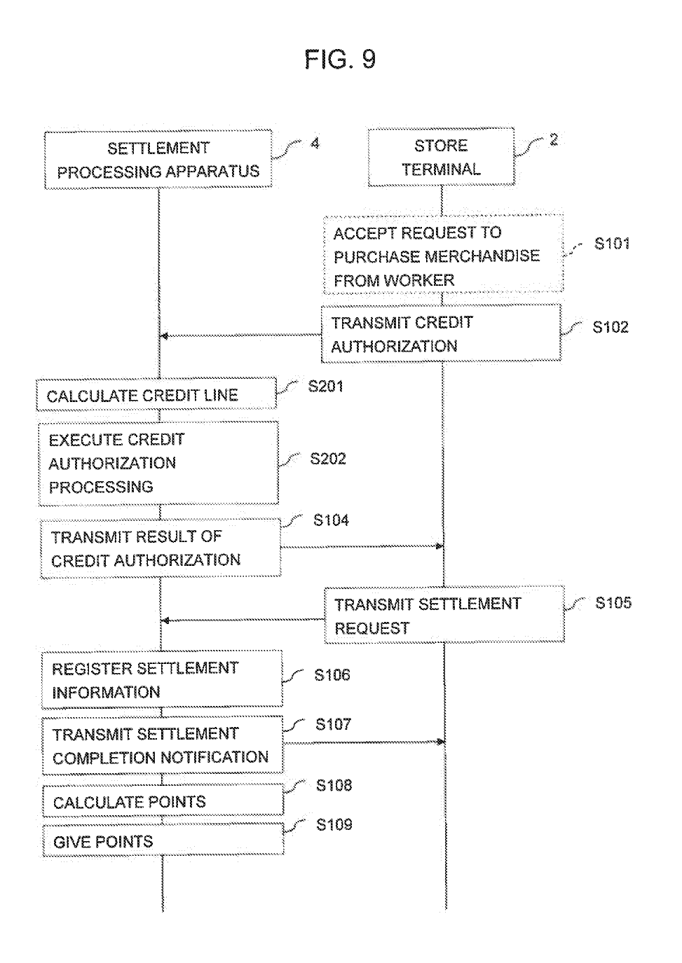

FIG. 9 illustrates the flow of processing performed by the settlement processing apparatus 4 of the present embodiment. Hots that for convenience of description, processing in FIG. 9 similar to the processing illustrated in FIG. 5 is assigned the same processing number as that assigned in FIG. 5.

First, a worker requests a merchandise purchase at a predetermined store, which then accepts the request (S101), Concerning a settlement involved in the merchandise purchase, the worker requests the store to perform the settlement by using the settlement processing apparatus 4 and at the same time provides information identifying the worker and required in the settlement by the settlement processing apparatus 4 to the store.

A store terminal 2 transmits to the settlement processing apparatus 4 a credit authorization along with the information identifying the worker and information on a requested amount for settlement required to purchase the merchandise (S102),

In response to the credit authorization transmitted, the credit line calculation unit 18 of the settlement processing apparatus 4 calculates a credit line (S201), That is, the credit line calculation unit 18 calculates the settleable amount as the credit line by referring to the salary information DB 1B and the settlement information DB 1C and deducting the settlement amount from the expected salary.

Once the settleable amount is calculated, the credit authorization processing unit 11 executes credit authorization processing (S202). That is, the credit authorization processing unit 11 first determines whether or not the requested amount for settlement required to purchase the merchandise falls within the credit line which is set to the settleable amount calculated by the credit line calculation unit 18.

A result of the credit authorization is transmitted to the store terminal 2 (S104) and, when the worker is eligible for credit, a settlement request is transmitted from the store terminal 2 to the settlement processing apparatus 4 (S105).

The settlement processing apparatus 4 receiving the settlement request from the store terminal 2 executes settlement processing by using the settlement processing unit 12 (S106) and, upon completion of the settlement processing, uses the communication processing unit 17 to transmit a notification to the effect that the settlement processing is completed to the store terminal 2 (S107).

When the settlement is completed, the point calculation unit 15 calculates a predetermined number of points by referring to the settlement information DB 1C and multiplying the settlement amount by a predetermined rate (S108). The point giving unit 16 then refers to the settlement information DB 1C, stores the points calculated by the point calculation unit 15 in association with the worker, and gives the points to the worker (S109).

According to the settlement processing apparatus 4 of the present embodiment, the worker can perform a credit transaction without exceeding the expected salary.

While the present embodiment is adapted to perform the processing of calculating the credit line in response to the credit authorization from the store terminal 2, the settleable amount as the credit line may be calculated in advance at a predetermined timing and registered in the settlement information DB 1C so that the settleable amount registered in the settlement information DB 1C is referenced at the time of the credit authorization processing.

Moreover, while the credit line calculation unit 18 of the settlement processing apparatus 4 of the present embodiment calculates the settleable amount obtained by deducting the settlement amount from the expected salary as the credit line, another example may be adapted to calculate the settleable amount by multiplying the expected salary of the worker by a predetermined rate. That is, the predetermined rate such as sixty thousand yen corresponding to 20% of the salary of three hundred thousand yen may be set in advance to allow the worker to perform a settlement within the set range so that overspending can be prevented. The settleable amount can also be calculated by deducting the settlement amount from the amount multiplied by the predetermined rate.

Furthermore, according to another example, a part of the expected salary can be converted into a settlement point at a predetermined rate to allow a worker to perform a transaction with a balance of the settlement point as the settleable amount at a store having an arrangement about the use of the settlement point. Overspending can be prevented in this example as well since the transaction is allowed only at the predetermined rate.

Note that in the aforementioned embodiments of the present invention, the credit line for settlement is set to the expected salary to be paid to the worker or the settleable amount determined by deducting the settlement amount from the expected salary, where the expected salary is the total of the confirmed amount based on the work record up to that point and the expected amount based on a future work schedule. Here, the expected salary set as the credit line can correspond only to the confirmed amount based on the work record of the worker up to that point.

Information related to the confirmed amount based on the work record of the worker may for example be accumulated in a personnel and labor information database configured to be able to perform data communication with the settlement processing apparatuses 1 and 4, so that one may refer to the database. In this case, the personnel and labor information database is configured as a database accumulating information related to the personnel and labor management of the worker, and stores the confirmed amount of the salary that is based on the work record of the worker up to that point and is calculated from clock-in/out information of the worker acquired as needed by a time clock or the like configured to be able to perform data communication, working hours determined from the clock-in/out information, and the salary and deduction per unit time of the worker.

The personnel and labor information database updates the confirmed amount of the salary of the worker as needed depending on the labor of the worker, thereby enabling settlement processing in which the salary confirmed at the point the worker requires settlement is used as security.

With the confirmed salary of the worker being used as the security tor the settlement, the worker does not need to pay an interest as when he borrows money, and a store has a low risk for an irrecoverable payment because the payment is made to the store from an account of a company the worker works for, for example.

Information, that can identify the worker and is required when the worker requests the store to make settlement by using the settlement processing apparatus 1 can be held on various things such as a mobile terminal with a built-in IC card or IC chip.

1. A settlement processing apparatus which is configured to be able to communicate with a store terminal selling merchandise to a worker through a network and performs a credit transaction that pays for the worker when he purchases merchandise on the basis of an expected salary scheduled to be paid to the worker, the apparatus comprising:
a salary information storage unit that stores salary information including the expected salary of the worker;
a settlement information storage unit that stores settlement information including a settlement amount for the merchandise purchased by the worker;
a credit authorization reception unit that receives a credit authorization along with information on a requested amount for settlement from the store terminal, the amount being required in the merchandise purchase;
a credit authorization processing unit that executes credit authorization processing with a credit line set to the expected salary of the worker while referring to the salary information storage unit;
a result transmission unit that transmits a result of the credit authorization processing to the store terminal;
a settlement request reception unit that receives a settlement request from the store terminal;
a settlement processing unit that registers settlement information in the settlement information storage unit on the basis of the settlement request; and
a payment calculation unit that calculates a salary payment by referring to the salary information storage unit and the settlement information storage unit and deducting the settlement amount from the expected salary.

2. The settlement processing apparatus according to claim 1, further comprising a salary payment processing unit that executes salary payment processing of paying the calculated salary payment to the worker.

3. The settlement processing apparatus according to claim 1, further comprising a first credit line calculation unit that calculates, as the credit line, a first settleable amount by referring to the salary information storage unit and the settlement information storage unit and deducting the settlement amount from the expected salary,
wherein the credit authorization processing unit executes credit authorization processing with the credit Hoe set to the first settleable amount.

4. The settlement processing apparatus according to claim 1, further comprising a second credit line calculation unit that calculates, as the credit line, a second settleable amount by referring to the salary information storage unit and multiplying the expected salary of the worker by a predetermined rate,
wherein the credit authorization processing unit executes credit authorization processing with the credit line set to the second settleable amount.

5. The settlement processing apparatus according to claim 4, wherein the second credit line calculation unit calculates, as the credit line, a third settleable amount by referring to the salary information storage unit and the settlement information storage unit, multiplying the expected salary of the worker by a predetermined rate, and subtracting the settlement amount from a product of the multiplication.

6. The settlement processing apparatus according to claim 1, further comprising:
a point calculation unit that calculates a predetermined number of points by referring to the settlement information storage unit and multiplying the settlement amount by a predetermined rate; and
a point giving unit that associates the calculated number of points with the worker by referring to the settlement information storage unit and gives the points to the worker.

7. A settlement processing method employed to perform a credit transaction that pays for a worker when he purchases merchandise on the basis of an expected salary scheduled to be paid to the worker, wherein a computer configured to be able to communicate with a store terminal selling merchandise to the worker through a network includes;
a salary information storage unit that stores salary information including the expected salary of the worker; and
a settlement information storage unit that stores settlement information including a settlement amount for the merchandise purchased by the worker, and the method causes the computer to execute:
processing that receives a credit authorization along with information on a requested amount for settlement from the store terminal, the amount being required in the merchandise purchase;
processing that executes credit authorization processing with a credit line set to the expected salary of the worker while referring to the salary information storage unit;
processing that transmits a result of the credit authorization processing to the store terminal;
processing that receives a settlement request from the store terminal;
processing that registers settlement information in the settlement information storage unit on the basis of the settlement request; and
processing that calculates a salary payment by referring to the salary information storage unit and the settlement information storage unit, and deducting the settlement amount from the expected salary.

8. A non-transitory computer-readable medium which is employed to perform a credit transaction that pays for a worker when he purchases merchandise on the basis of an expected salary scheduled to be paid to the worker, wherein a computer configured to be able to communicate with a store terminal selling merchandise to the worker through a network includes:
a salary information storage unit that stores salary information including the expected salary of the worker; and
a settlement information storage unit that stores settlement information including a settlement amount for the merchandise purchased by the worker, and the computer program causes the computer to execute:
processing that receives a credit authorization along with information on a requested amount for settlement from the store terminal, the amount being required in the merchandise purchase;
processing that executes credit authorization processing with a credit line set to the expected salary of the worker while referring to the salary information storage unit;
processing that transmits a result of the credit authorization processing to the store terminal;
processing that receives a settlement request from the store terminal;
processing that registers settlement information in the settlement information storage unit on the basis of the settlement request; and
processing that calculates a salary payment by referring to the salary information storage unit and the settlement information storage unit, and deducting the settlement amount from She expected salary.

9. The settlement processing apparatus according to claim 2, further comprising a first credit line calculation unit that calculates, as the credit line, a First settleable amount by referring to the salary information storage unit and the settlement information storage unit and deducting the settlement amount from the expected salary,
wherein the credit authorization processing unit executes credit authorization processing with the credit line set to the first settleable amount.

10. The settlement processing apparatus according to claim 2, further comprising a second credit line calculation unit that calculates, as the credit line, a second settleable amount by referring to the salary information storage unit and multiplying the expected salary of the worker by a predetermined rate,
wherein the credit authorization processing unit executes credit authorization processing with the credit fine set to the second settleable amount.

11. The settlement processing apparatus according to claim 10, wherein the second credit line calculation unit calculates, as the credit line, a third settleable amount by referring to the salary information storage unit and the settlement information storage unit, multiplying the expected salary of the worker by a predetermined rate, and subtracting the settlement amount from a product of the multiplication.

12. The settlement processing apparatus according to claim 2, further comprising:
a point calculation unit that calculates a predetermined number of points by referring to the settlement information storage unit and multiplying the settlement amount by a predetermined rate; and
a point giving unit that associates the calculated number of points with the worker by referring to the settlement information storage unit and gives the points to the worker.

13. The settlement processing apparatus according to claim 3, further comprising:
a point calculation unit that calculates a predetermined number of points by referring to the settlement information storage unit and multiplying the settlement amount by a predetermined rate; and
a point giving unit that associates the calculated number of points with the worker by referring to the settlement information storage unit and gives the points to the worker.

14. The settlement processing apparatus according to claim 4, further comprising:
a point calculation unit that calculates a predetermined number of points by referring to the settlement information storage unit and multiplying the settlement amount by a predetermined rate; and
a point giving unit that associates the calculated number of points with the worker by referring to the settlement information storage unit and gives the points to the worker.

15. The settlement processing apparatus according to claim 5, further comprising:
a point calculation unit that calculates a predetermined number of points by referring to the settlement information storage unit and multiplying the settlement amount by a predetermined rate; and
a point giving unit that associates the calculated number of points with the worker by referring to the settlement information storage unit and gives the points to the worker.

16. The settlement processing apparatus according to claim 9, further comprising:
a point calculation unit that calculates a predetermined number of points by referring to the settlement information storage unit and multiplying the settlement amount by a predetermined rate; and
a point giving unit that associates the calculated number of points with the worker by referring to the settlement information storage unit and gives the points to the worker.

17. The settlement processing apparatus according to claim 10, further comprising:
a point calculation unit that calculates a predetermined number of points by referring to the settlement information storage unit and multiplying the settlement amount by a predetermined rate; and
a point giving unit that associates the calculated number of points with the worker by referring to the settlement information storage unit and gives the points to the worker.

18. The settlement processing apparatus according to claim 11, further comprising:
a point calculation unit that calculates a predetermined number of points by referring to the settlement information storage unit and multiplying the settlement amount by a predetermined rate; and
a point giving unit that associates the calculated number of points with the worker by referring to the settlement information storage unit and gives the points to the worker.
